(19) United States
(12) Patent Application Publication
(10) Pub. No.: US 2007/0003101 A1
(43) Pub. Date: Jan. 4, 2007

(54) Speaker basin structure

(75) Inventor: Chang-Chien Yang, Sioushuel Township (TW)

Correspondence Address: BRUCE H. TROXELL, SUITE 1404, 5205 LEESBURG PIKE, FALLS CHURCH, VA, 22041, US

(73) Assignee: Sunfield Enterprise Corporation

(21) Appl. No.: 11/256,073

(22) Filed: Oct. 24, 2005

(30) Foreign Application Priority Data
May 26, 2005 (TW) 94208610

(51) Int. Cl. H04R 9/06

(52) U.S. Cl. 381/433

(57) ABSTRACT

A speaker basin structure made from a thermosetting composite material such as TMC, BMC and SMC. The speaker basin structure has a front tray with larger diameter and a rear tray with smaller diameter. A conic bracket is interconnected between the front and rear trays. The front tray serves to support an outer circumference of a vibrational basin cover. An audio electromagnetic unit is mounted on the rear tray.

### BACKGROUND OF THE INVENTION

The present invention is related to an improved speaker basin structure, and more particularly to a speaker basin structure made from a thermosetting material.

A speaker works by way of the variation of intensity of current. The coil of the speaker will attract and repel a magnet to induce a magnetic field for emitting sound. In other words, the speaker converts electric signal into audio signal. The larger the mass of the magnet used in the speaker is, the greater the generated magnetic field is. In addition, the heavier the speaker is, the higher the required power is and the greater the generated covibration of the periphery of the speaker is. Such covibration not only will lead to offset and loss of power, but also will freely spread to the entire speaker bracket or speaker cabinet. As a result, within a playing range of 20 hertz to 20 kilohertz, the audio signal of the speaker is often distorted or twisted.

The above shortcomings long exist in the early metal-made speaker basins. The metal-made speaker basin can hardly effectively restrain the vibrational wave. Therefore, the sound played from the speaker can hardly achieve a pleasing audio effect. Improved manufacturing techniques of the speakers have been developed recently. Other substitutive materials or measures have been widely employed to try to restrain the distortion and reduce the covibration generated when the speaker plays the sound.

Furthermore, the conventional speaker basin is made from metal material by means of punch or casting. According to such measure, the cost for the material is relatively high and the processing procedure is complicated as well as the molding effect is poor. (The metal material needs to be punched many times. ) Moreover, the magnetic driving circuit of the speaker and the speaker basin tend to incur magnetic induction and magnetic leakage. Therefore, it is necessary to additionally insulate the speaker basin. This will lead to audio loss. Some measures have been disclosed for eliminating the above shortcomings existing in the conventional speaker as follows:
1. A soft pad is mounted between the speaker and the bracket or the speaker cabinet for absorbing or reducing over-vibration caused by the electromagnetic field effect. That is, the soft pad can absorb the air vibration caused by the reciprocal contraction and expansion of the vibratory membrane when the electrodes attract or repel. Therefore, the covibrat ion can be minified. However, such design will greatly distort or twist the output and lead to unpleasing sound. This is especially apparent at low frequency.
2. The support strength of the speaker basin is enhanced or the shell of the basin is solidified to push the covibrational mode of the speaker to a high frequency so as to reduce the noise. However, this does mean that the covibration effect will disappear in the high frequency state. Moreover, no matter whether the support strength is enhanced or the shell of the basin is solidified, the total weight of the speaker will be greatly increased. Therefore, it will be hard to transfer the speaker. Also, the vibration may be magnified.
3. Damping materials or compounds are added to outer side of the speaker. However, this will increase cost and prolong manufacturing time. Also, this may incur the shortcoming of item 2.
4. A heavy stopper board (such as bakelite or fiber board) is added to the speaker assembly to reinforce the speaker structure. The heavy stopper board necessitates complicated lining system and screws for assembly. Similarly, this increases the total weight of the speaker.

Therefore, it is tried by the applicant to provide an improved speaker basin structure for solving the above problems.

### SUMMARY OF THE INVENTION

It is therefore a primary object of the present invention to provide a speaker basin structure integrally made from a thermosetting composite material such as thick molding compound (TMC), sheet molding compound (SMC) and bulk molding compound (BMC). The speaker basin provides high damping effect and antivibration capability. In covibrational mode, distortion or twist of the sound played by the speaker is not easy to happen. The speaker basin structure has a front tray with larger diameter and a rear tray with smaller diameter. A conic bracket is interconnected between the front and rear trays. The front tray serves to support a vibrational basin cover and enclose a damper. An audio electromagnetic unit is mounted on the rear tray. The thermosetting composite material (TMC, BMC or SMC) is easy to process and has suitable stiffness and good damping effect. Therefore, the speaker basin structure integrally made from the thermosetting composite material can well support the vibrational basin cover. Moreover, the thermosetting composite material has elasticity better than that of metal material. Therefore, in vibration of the coil of the speaker, the thermosetting composite material can effectively restrain the covibration so as to achieve better audio effect.

The present invention can be best understood through the following description and accompanying drawings wherein:

### BRIEF DESCRIPTION OF THE DRAWINGS

FIG. 1 is a perspective exploded view of the present invention;

FIG. 2 is a sectional assembled view of the present invention; and

FIG. 3 is a perspective assembled view of the present invention.

### DETAILED DESCRIPTION OF THE PREFERRED EMBODIMENTS

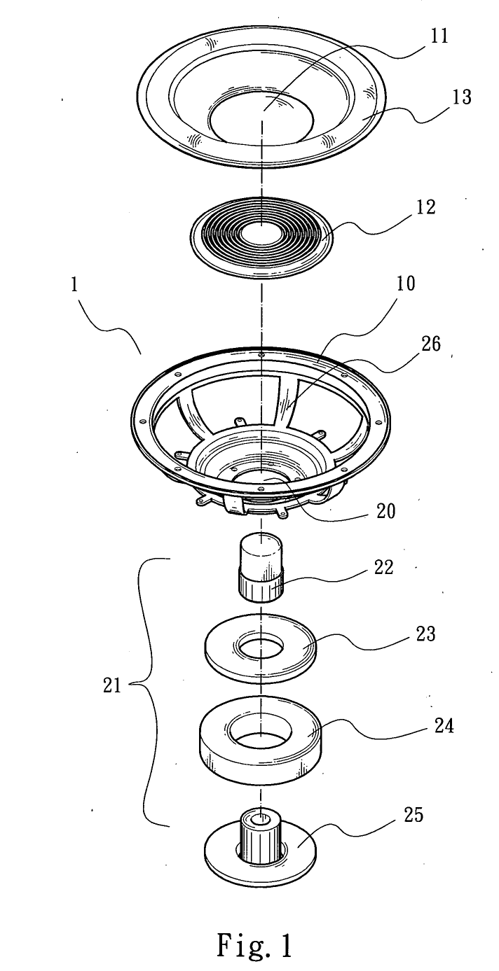

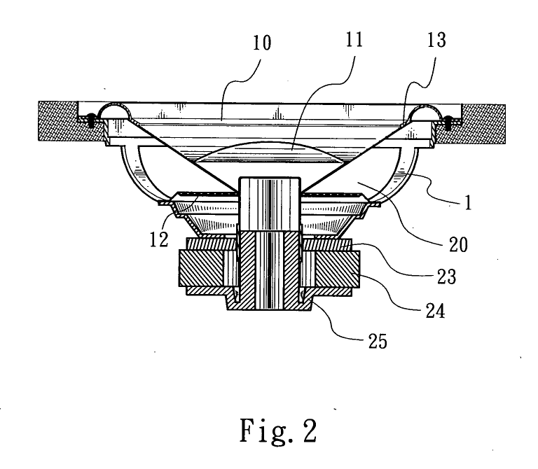

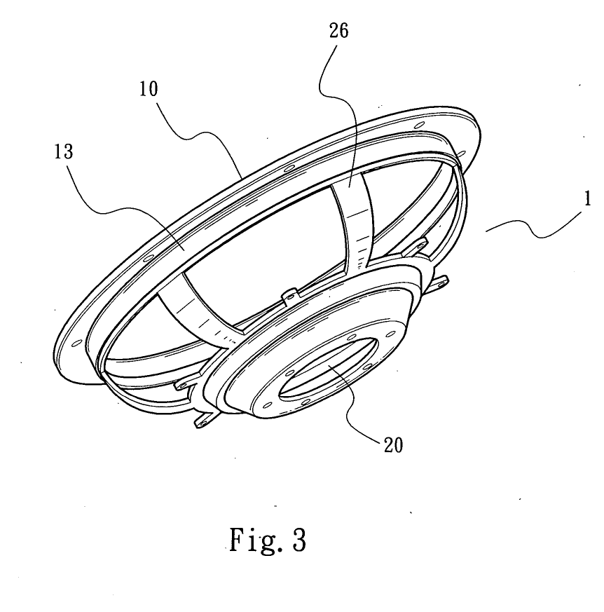

Please refer to FIGS. 1 to 3. The speaker basin 1 of the present invention is made from a thermosetting material. The speaker basin 1 has a front tray 10 with larger diameter and a rear tray 20 with smaller diameter. A conic bracket 26 is interconnected between the front and rear trays 10, 20. The front tray 10 serves to support an outer circumference 13 of a vibrational basin cover 11. An audio electromagnetic unit 21 and a damper 12 are mounted on the rear tray 20. The damper 12 is arranged between the front and rear trays 10, 20. The audio electromagnetic unit 21 includes a coil 22, a metal disc 23, a magnetic member 24 and an electromagnetic disc 25.

In this embodiment, the thermosetting material can be TMC, BMC or SMC. Other filling materials (such as fiber glass) can be selectively added to and bonded with these compounds to enhance the surface strength. Alternatively, fillings such as wood powder, mica, calcium and composite rubber material can be added to the compounds to enhance the beauty of the appearance and to develop the quality of the materials.

Preferably, the speaker basin 1 is made from the thermosetting material (TMC, BMC or SMC) by means of press mold, injection mold, double-injection mold, vacuum or press thermal molding.

In general, the rim of the front tray 10 and the rim of the rear tray 20, which are adjoined with the conic bracket 26 are relatively weak. In a preferred embodiment of the present invention, suitable additives are bonded with the thermosetting material (TMC, BMC or SMC) to reinforce the weaker parts of the speaker basin 1. Accordingly, over-vibration of the weaker parts caused by covibration mode of the speaker can be relieved or reduced. For example, BMC material is an integral bulk block, not a sheet material. In manufacturing procedure of BMC material, an additive of short fibers can be added to the BMC material to reinforce the structure of the product. SMC is a sheet molding material. An additive of long fibers can be added to the SMC material to reinforce the structure of the product. With respect to TMC material, fibers with a length between long fibers and short fibers can be added to the TMC material to increase the strength of speaker basin 1.

It should be noted that the BMC, SMC or TMC material employed in the present invention has a rigidity and strength better than those of plastics or composite resins. Moreover, the BMC, SMC or TMC material provides better flexibility for enhancing the capability of restraining covibration. In addition, the present invention can solve the problem of distortion or twist of the conventional metal-made speaker basin, which takes place within a specific frequency playing range. Also, the present invention can avoid audio loss due to magnetic leakage.

In comparison to the manufacturing procedure of the conventional speakers, the present invention builds a modularized production to save manufacturing cost.

The above embodiments are only used to illustrate the present invention, not intended to limit the scope thereof. Many modifications of the above embodiments can be made without departing from the spirit of the present invention.

What is claimed is:

1. A speaker basin structure made from a thermosetting composite material, the speaker basin structure having a front tray with larger diameter and a rear tray with smaller diameter, a conic bracket being interconnected between the front and rear trays, the front tray serving to support an outer circumference of a vibrational basin cover, an audio electromagnetic unit being mounted on the rear tray.

2. The speaker basin structure as claimed in claim 1, wherein the thermosetting composite material is BMC material.

3. The speaker basin structure as claimed in claim 1, wherein the thermosetting composite material is SMC material.

4. The speaker basin structure as claimed in claim 1, wherein the thermosetting composite material is TMC material.

5. The speaker basin structure as claimed in claim 1, wherein fiber materials are added to the thermosetting composite material to reinforce the speaker basin structure.

6. The speaker basin structure as claimed in claim 2, wherein fiber materials are added to the BMC material to reinforce the speaker basin structure.

7. The speaker basin structure as claimed in claim 3, wherein fiber materials are added to the SMC material to reinforce the speaker basin structure.

8. The speaker basin structure as claimed in claim 4, wherein fiber materials are added to the TMC material to reinforce the speaker basin structure.

9. The speaker basin structure as claimed in claim 1, wherein at least one of the following fillings such as wood powder, mica, calcium and composite rubber material or so is added to the thermosetting material.

10. The speaker basin structure as claimed in claim 2, wherein at least one of the following fillings such as wood powder, mica, calcium and composite rubber material or so is added to the thermosetting material.

11. The speaker basin structure as claimed in claim 3, wherein at least one of the following fillings such as wood powder, mica, calcium and composite rubber material or so is added to the thermosetting material.

12. The speaker basin structure as claimed in claim 4, wherein at least one of the following fillings such as wood powder, mica, calcium and composite rubber material or so is added to the thermosetting material.

13. The speaker basin structure as claimed in claim 5, wherein at least one of the following fillings such as wood powder, mica, calcium and composite rubber material or so is added to the thermosetting material.

14. The speaker basin structure as claimed in claim 6, wherein at least one of the following fillings such as wood powder, mica, calcium and composite rubber material or so is added to the thermosetting material.

15. The speaker basin structure as claimed in claim 7, wherein at least one of the following fillings such as wood powder, mica, calcium and composite rubber material or so is added to the thermosetting material.

16. The speaker basin structure as claimed in claim 8, wherein at least one of the following fillings such as wood powder, mica, calcium and composite rubber material or so is added to the thermosetting material.

17. The speaker basin structure as claimed in claim 1, wherein the speaker basin structure is made from the thermosetting material by means of at least one of the followings such as press mold, injection mold, double-injection mold, vacuum or press thermal molding.

18. The speaker basin structure as claimed in claim 2, wherein the speaker basin structure is made from the thermosetting material by means of at least one of the followings such as press mold, injection mold, double-injection mold, vacuum or press thermal molding.

19. The speaker basin structure as claimed in claim 3, wherein the speaker basin structure is made from the thermosetting material by means of at least one of the followings such as press mold, injection mold, double-injection mold, vacuum or press thermal molding.

20. The speaker basin structure as claimed in claim 4, wherein the speaker basin structure is made from the thermosetting material by means of at least one of the followings such as press mold, injection mold, double-injection mold, vacuum or press thermal molding.

21. The speaker basin structure as claimed in claim 5, wherein the speaker basin structure is made from the thermosetting material by means of at least one of the followings such as press mold, injection mold, double-injection mold, vacuum or press thermal molding.

22. The speaker basin structure as claimed in claim 6, wherein the speaker basin structure is made from the thermosetting material by means of at least one of the followings such as press mold, injection mold, double-injection mold, vacuum or press thermal molding.

23. The speaker basin structure as claimed in claim 7, wherein the speaker basin structure is made from the thermosetting material by means of at least one of the followings such as press mold, injection mold, double-injection mold, vacuum or press thermal molding.

24. The speaker basin structure as claimed in claim 8, wherein the speaker basin structure is made from the thermosetting material by means of at least one of the followings such as press mold, injection mold, double-injection mold, vacuum or press thermal molding.
